(19) United States
(12) Patent Application Publication
(10) Pub. No.: US 2005/0211631 A1
(43) Pub. Date: Sep. 29, 2005

(54) Method for the separation of zinc and a second metal which does not form an anionic complex in the presence of chloride ions

(76) Inventors: Pascal Muller, Marly (FR); Athmane Benchara, Mantes-La-Jolie (FR); Eric Meux, Pournoy-La-Grasse (FR); Pierre Devigili, Aumetz (FR)

Correspondence Address: COHEN, PONTANI, LIEBERMAN & PAVANE, 551 FIFTH AVENUE, SUITE 1210, NEW YORK, NY, 10176, US

(21) Appl. No.: 10/502,497

(22) PCT Filed: Jan. 22, 2003
(86) PCT No.: PCT/FR03/00212

§ 371 Date: May 29, 2005

(30) Foreign Application Priority Data
Jan. 23, 2002 (FR) 0200816

(51) Int. Cl. C02F 1/42

(52) U.S. Cl. 210/638

(57) ABSTRACT

A method for the separation of zinc and a second metal which does not form an anionic complex in the presence of chloride ions, zinc and the second metal being present in an effluent in the form of ZnCl2 and a second metal chloride. The formation of the anionic complex is obtained by bringing the effluent into contact with the resin saturated with chloride ions. The second metal chloride is extracted by means of a first eluent, followed by extraction of zinc with a degree of oxidation of +II. Generally, the second metal is a transition metal such as Cr, Cu, Ni, Fe and, more specifically, nickel.

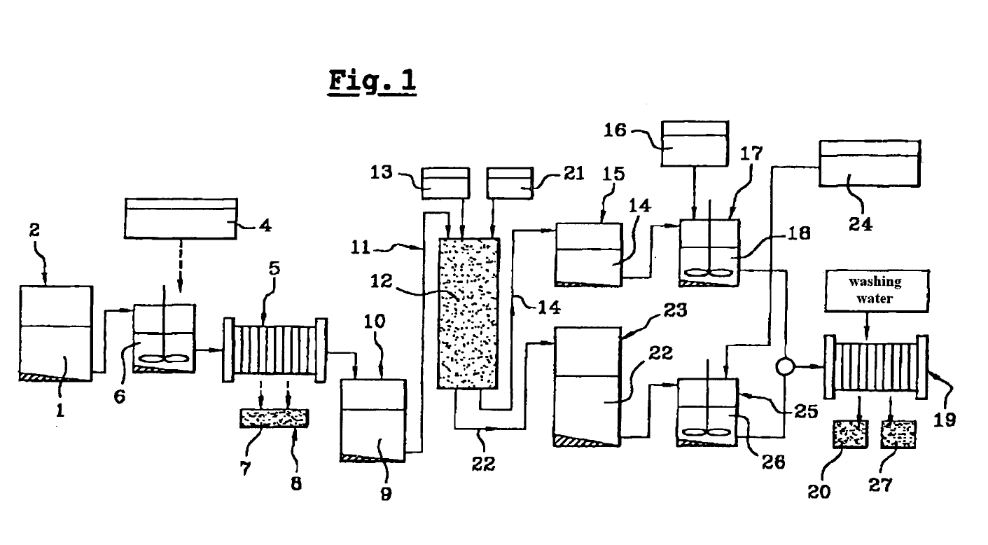

The present invention relates to a process for separation of zinc and a second metal not forming a stable anionic complex in the presence of chloride ions.

Even though the present invention relates in general to the separation of zinc and a second metal presenting such a property in the presence of chloride ions, the following description is more specifically illustrated by the process of separating zinc and nickel, without the latter limiting the scope of the invention in any way at all.

Currently, particular attention is given to the treatment of waste, and especially that originating from the chemical and metallurgy industries.

In the particular case of industrial processes using metallic catalysts, the problem of the treatment of organic sludge arises.

Generally, this sludge is incinerated and the fumes produced by this incineration are then treated by humid means.

This type of process helps recover metals, in ionic form, in effluents.

Then the problem arises of the retreatment of effluents and, more precisely, of the potential improvement, which can be done of the products, including metals, contained in these effluents.

In the particular industry of Nylon®, the metals found in effluent, after treatment by humid means, are principally zinc and nickel, in the form of chlorides ZnCl2 and NiCl2.

An example of classic composition of such an effluent is given hereinbelow, the concentrations being indicated in g/1:
Cl: 200±50
Zn: 140±40
Ni: 37±10
Ca: 19±5

To date, methods of classic separation of metals have proven ineffective in isolating zinc and nickel.

In effect, since these metals have very similar chemical properties, the physical-chemical methods of separation of precipitation type or the electrochemical processes of separation such as electro-deposition are not satisfactory.

The aim of the present invention is therefore to propose a process enabling efficacious separation of zinc and the second metal with the immediate advantage of proposing improvement for each of the metals in their respective dies.

The present invention thus concerns a separation process for zinc and a second metal not forming an anionic complex in the presence of chloride ions, with zinc and second metal being present in an effluent in the form of ZnCl₂ and second metal chloride. This process consists of forming and fixing the anionic complex ZnCl⁻₃ on a resin.

According to the invention, this process is characterised in that the formation of anionic complex is obtained by bringing the effluent in contact with the resin saturated in chloride ions, and in that the process further comprises the stages of:
extraction of the second metal chloride by means of a first eluent, then
extraction of the zinc with a degree of oxidation +II.

Contrary to the second metal, zinc has the particularity of forming an anionic ZnCl₃⁻ complex in the presence of a quantity or adapted concentration of chloride ions, the second metal remaining in the form of non-ionic metal chloride, under these same conditions of quantity or particular concentration of chloride ions.

In particular, the second metal can be transition metal, preferably selected from Cr, Cu, Ni, and Fe.

Because of this behaviour difference existing between this second metal and zinc vis-à-vis chloride ions, it is thus possible to adsorb the anionic complex of ZnCl₃⁻ formed on an adapted resin, and to extract, by elution, the second metal in the form of chloride, for example nickel in the form of NiCl₂ or iron in the form of FeCl₂, FeCl₃ or a mixture of FeCl₂ and FeCl₃.

Nickel, iron, as well as any other second metal in terms of the present invention, can advantageously be recycled, directly or after adapted treatment, and each improved in adapted dies, in particular in the metallurgy industry. They can, for example, be reused in processes for transforming metals-from minerals.

After extraction of the second metal in the form of chloride, it remains to proceed with extraction of the zinc with its degree of oxidation +II for which several methods are proposed.

A first way consists of extracting the Zn with the degree of oxidation +II by means of a second eluent allowing dilution of the concentration of chloride ions, the effect of which is to dissociate the ZnCl₃⁻ complex according to the reaction:
ZnCl₃⁻→ZnCl₂+Cl⁻
resin resin
ZnCl₂, which has no further affinity with the resin, can then be extracted.

A second way consists of realising a desorption stage for the zinc with its degree of oxidation +II by transformation, by means of a reagent, of the ZnCl₃⁻ complex into a zinc complex more stable than the ZnCl₃⁻ complex, and non absorbed by the resin.

A third way consists of realising an electrolytic desorption stage for the zinc with its degree of oxidation +II.

In the particular case of effluents such as that whereof the composition has been given hereinabove, it is necessary to proceed to a previous stage of treatment to extract the calcium (Ca₂+ in solution) present in the effluent.

In effect, recycling for the zinc and the second metal, and in particular, their reintroduction as co-product to the metallurgic dies of transformation of metals from minerals, is possible only if the calcium content is very low.

Other characteristics and advantages of the invention will emerge from the following description, given by way of non-limiting example and presented in reference to the attached figure, which constitutes a schematic view of an installation for use within the scope of implementing the process according to the invention.

It is specified that the parameters and results indicated hereinbelow concern non-optimised operating of a prototype installation on the scale of the pilot, but suffice to demonstrate the interest of the present invention.

In reference to the attached figure, 10 liters of initial effluent 1 were introduced to a vat 2.

The composition of the effluent 1 is in accordance with that indicated previously, namely (in g/l):
Cl⁻ 200±50
Zn: 140±40
Ni: 37±10
Ca: 19±5

The elements specified hereinafter for the separation of zinc and the second metal, in the form of nickel, contained in the effluent 1 are transposable mutatis mutandis to an effluent which would contain zinc and a second metal such as Fe, Cr, Cu for example: as a consequence, there is room to consider that the information mentioned concerning nickel or nickel chloride can be read as applying to the second metal or to the second metal chloride.

The presence of calcium in the effluent 1 imposes, as indicated previously, prior treatment of the effluent 1, especially before the formation of the anionic ZnCl₃⁻ complex, to extract calcium therefrom.

This treatment is performed in a vat 3 in which are introduced on the one hand the effluent 1 from the vat 2 and on the other hand a reagent 4 the aim of which is to allow extraction of the calcium.

This reagent 4 can advantageously be sulphuric acid, added in stoichiometric quantities.

After introduction, in a solid/liquid separator 5, of the mixture 6 constituted by the added effluent 1 of sulphuric acid 4, precipitation of calcium hydrate sulphate CaSO₄, xH₂O, or gypsum 7, is obtained, collected in the receptacle 8.

The chemical reaction utilised in this preliminary stage is the following:
CaCl₂+H₂SO₄+xH₂O-+CaSO₄, xH₂O+2HCl

For 10 l of effluent 1 introduced 0.5 kg H₂SO₄ at 98% allowed 1.6 kg of gypsum 7 of formula CaSO₄, 2H₂O to be precipitated, containing from 20 to 30% interstitial water.

The composition of the gypsum 7 thus obtained, after drying at 105° C. to a constant mass, is the following, in % solid:
Ca: 27.5
Zn: 0.18
S: 20.8
Cl: 0.18
Si: 0.3
Ni: 0.06

This composition is very close to the theoretical values calculated for pure gypsum: actually, the theoretical percentages calculated give the following values (for x=0.5):
Ca 27.5
S 22.0

Considering its considerable purity, the gypsum 7 can easily be recycled in the dies of the graveyard and/or of the plaster works.

After passing through the solid/liquid separator 5, the effluent 9, constituted by the initial effluent deprived of calcium, is introduced to a vat 10 for later introduction to the separation column 11 having a capacity of 60 l, filled internally with resin 12.

By way of example, the resin can be formed from a styrene-divinylbenzene copolymer skeleton and from a functional N(CH₃)₃^{±} group in ionic form.

In the present case, the resin 12 used is a resin of “Hewatitt” type.

Prior to the introduction of the effluent 9 to the column 11, saturation of the resin 12 was performed by introduction of a hydrochloric acid HCl solution, or sodium chloride NaCl, for the purpose of producing a medium concentrated in chloride ions.

Such a medium concentrated in chloride ions is in effect favourable to the formation of the anionic ZnCl₃⁻ complex.

This saturation stage of the resin 12 is performed by the addition of a solution of chlorides in the form of HCl, NaCl, KCl . . . whereof the equivalent concentration in chloride ions is greater than or equal to 0.7 mol/l approximately and, preferably, between 1 and 1.3 mol/l approximately.

Within the framework of the treatment illustrated for the effluent 1 defined hereinabove, saturation of the resin 12 was carried out by introduction, at a rate of the order of 0.45 l/mn, of 35 l of a solution of HCl at an equivalent concentration of chloride ions of 1 mol/l.

It is evident that the formation and fixing of the Zn in the form of ZnCl₃⁻ on the resin 12 is observed in this stage.

After saturation of the resin 12 under the abovementioned conditions, the effluent 9 is introduced, at constant speed and at the rate of 2 l/mn, to the upper part of the column 11, while the lower part of this column 11 is blocked, during this operation for introduction of the effluent 9.

The Zn with the degree of oxidation +II is fixed on the resin 12 in the form of the anionic ZnCl₃⁻ complex.

A possible alternative consists of introducing, directly to the vat 10 containing the effluent 9, an adapted quantity of chloride ions favouring formation of the anionic ZnCl₃⁻ complex.

This effluent 9, comprising the anionic ZnCl₃⁻ complex, is then introduced to the column 11, the Zn with the degree of oxidation +II then being fixed on the resin 12.

In any case, the following stage consists of extracting, via a first eluent 13, the nickel chloride NiCl₂ present in the effluent 9 and which has not been absorbed by the resin 12.

This first eluent 13 can be a solution of hydrochloric acid HCl or sodium chloride NaCl.

Advantageously, this first eluent 13 has a concentration of chloride ions greater than or equal to 0.7 mol/l approximately and, preferably, between 1 and 1.3 mol/l approximately. Such a concentration of chloride ions does allow the zinc to be kept in its complex form ZnCl₃⁻ and thus absorbed on the resin 12, and consequently allow selective and optimised elution of the NiCl₂ present in the effluent 9.

By means of this first eluent 13 the elution product is an effluent 14, collected from the lower part of the column 11, open during this elution stage, and collected in the vat 15.

Advantageously, elution by means of this first eluent 13 is interrupted when the concentration of nickel in the effluent 14 at the outlet of column 11 becomes negligible.

This optimised stage of elution, and thus of separation of the nickel present in the effluent 1 then 9, was achieved after introduction to the column 11, at a rate of 2 l/mn, of 50 l of a solution of HCl or NaCl in an equivalent concentration of chloride ions of 1 mol/l.

This effluent 14 is accordingly constituted by a solution of pure nickel chloride NiCl₂, in which zinc is present only in a trace state, as will be verified hereinbelow.

The effluent 14 can then be used according to various treatments, including treatments aiming at improving the nickel itself.

By way of non-limiting example, the NiCl₂ extract can be made to react by the first eluent 13, and thus precipitate the Ni₂+ present in solution, with a precipitation reagent 16.

The effluent 14 is introduced to a precipitation vat 17 to which is added the precipitation reagent 16.

Preferably, the precipitation reagent 16 is an alkaline reagent, which forms nickel hydroxide Ni(OH)₂.

The alkaline reagent can advantageously be selected from amongst soda, lime, and potassium.

Advantageously, the precipitation reagent 16 is introduced until such time as a pH between 9.5 and 10.5 is obtained, where the nickel hydroxide is at its solubility minimum.

In general, the precipitation reagent 16 is introduced in quantities resulting in the pH corresponding to the minimum solubility of the second metal cation precipitate.

In the present case, the effluent 14 was placed in the presence of 4 l of soda (10 M) in the precipitation vat 17. Nickel hydroxide Ni(OH)₂ is formed according to the following chemical reaction:

NiCl₂+2NaOH→Ni(OH)₂+2NaCl

To optimise this stage of precipitation, and then the later filtration stage, a classic coagulant and/or floculant reagent can advantageously be added to the precipitation vat 17.

The solid-liquid 18 mixture obtained in the precipitation vat 17 is then introduced then separated by means of a filter press 19.

The solid phase is then washed in 60 l water in the filter press 19 and the cake of nickel hydroxide 20 is isolated.

1.5 kg of nickel hydroxide Ni(OH)₂ (60% water) was obtained.

This hydroxide 20, after drying at 105° C. to a constant mass, has the following composition, in % solid:
Ni: 58.6
S: 0.2
Cl: 1.9
Ca: 0.1
Na: 1.1
Zn: <0.1
Si: 0.8

These results confirm the particularly selective and high-performing separation of the nickel from the effluent 9, the quantity of zinc being effectively undetectable.

After elution of the nickel by means of the first eluent 13 with a view to its later treatment, the extraction stage of the zinc absorbed on the resin 12 is commenced.

Preferably, the extraction stage of the zinc with its degree of oxidation +II is performed only after complete extraction of NiCl₂, so as to optimise, not only the selective separation of the nickel, but also that of the zinc.

In practice, quantitative measures taken at the outlet of the column 11 help to define when the entirety of the nickel present in the effluent 9 has been extracted and is back in the effluent 14.

This extraction stage of the zinc can be executed according to several processes.

A first way consists of dissociating the anionic ZnCl₃⁻ complex to form free ZnCl₂. This dissociation is performed by means of a second eluent 21 allowing dilution, and thus the diminishing, of the concentration of chloride ions in the medium contained inside the column 11.

In the attached figure the stages corresponding to the first way of extracting the zinc are illustrated.

In such conditions, and for a concentration of chloride ions reaching, for example, a value less than 1 mol/l, the anionic ZnCl₃⁻ complex is dissociated and causes desorption of the zinc in the form of ZnCl₂ which passes into solution.

This second eluent 21 can be a solution of sodium chloride NaCl or water.

The elution product obtained by means of this second eluent 21 is an effluent 22, collected from the lower part of the column 11, open during this stage elution, and collected in the vat 23.

To optimise the yield of recovered zinc, elution by means of this second eluent 21 is interrupted when the concentration of zinc in the effluent 22 at the outlet of the column 11 can no longer be detected.

This optimised stage of elution, and thus of separation of the zinc present in the effluent 1 then 9, was achieved after introduction to the column 11, at a rate of 2 l/mn, of 210 l water.

This volume is greater than 200 l when elution with recycled water (originating from the present process) containing chlorides at a content of 10 g/l is commenced.

The effluent 22, constituted by a solution of perfectly pure zinc chloride ZnCl₂, can then be used according to various treatments, including treatments aiming at improving the zinc.

The ZnCl₂ extracted by the second eluent 21 can especially be made to react, and thus precipitate the Zn₂+ present in solution, with a precipitation reagent 24.

The effluent 22 is introduced to a precipitation vat 25 to which is added the precipitation reagent 24.

Preferably, the precipitation reagent 24 is an alkaline reagent, which helps to form the zinc hydroxide Zn(OH)₂.

The alkaline reagent can advantageously be selected from among soda, lime, and potassium.

Sulphur can also be used as precipitation reagent 24, allowing the formation of zinc sulphide ZnS.

Advantageously, the precipitation reagent 24 is introduced in quantities reaching the pH corresponding to the minimum of solubility of the Zn₂+ precipitate.

In the present case, the effluent 22 was placed in the presence of 2 l of soda (10 M) in the precipitation vat 25.

Zinc hydroxide Zn(OH)₂ is formed according to the following chemical reaction:
ZnCl₂+2NaOH→Zn(OH)₂+2NaCl

In the hypothesis where the effluent 22 is placed in the presence of sodium sulphide in the precipitation vat 25, zinc sulphide ZnS is formed according to the following chemical reaction:
ZnCl₂+Na₂S→ZnS+2NaCl

To optimise one or the other of these precipitation stages, then the later filtration stage, it is possible to add a coagulant and/or floculant reagent to the precipitation vat 25.

The solid-liquid mixture 26 obtained in the precipitation vat 25 is then introduced then separated by means of a filter press 19, which will have been emptied prior to the nickel hydroxide 20 collected during a preceding stage.

The solid phase is then washed in 60 l water in the filter press 19 then the cake of zinc hydroxide 27 is isolated.

5 kg of zinc hydroxide Zn(OH)₂ (60% water) were obtained.

This hydroxide 27, after drying at 105° C. to a constant mass, has the following composition, in % solid:
Zn: 62.5
Si: 0.6
Cl: 1.7
Ni: 0.2
Na: 0.9
S: 0.04
Ca. 0.7

It is confirmed that this zinc hydroxide 27 is of substantial purity and can be improved via transformation dies of zinc in the metallurgy industry.

A second way for extraction of the zinc consists of performing, after the extraction stage of NiCl₂, a desorption stage of zinc with the degree of oxidation +II.

The aim of this stage is to transform the anionic ZnCl₃⁻ complex adsorbed on the resin in a zinc complex, which is more stable than the ZnCl₃⁻ complex and is not adsorbed on the resin 12.

Quantitative desorption of the zinc is especially obtained when the desorption stage is performed by a solution of ammonia. The complex formed in this case is Zn(NH₃)₄²⁺.

A third possible way consists of carrying out, after the extraction stage of NiCl₂, an electrolytic desorption stage of the zinc with its degree of oxidation +II.

To accomplish this, the resin 12 on which is formed the anionic ZnCl₃⁻ complex is extracted from the column 11 and placed on a permeable membrane, this membrane itself being positioned between two electrodes.

The application of a difference in electric potential between these two electrodes allows desorption, electromigration and thus extraction of the zinc with the degree of oxidation +II.

Of course, the present invention is not limited to the example of using the process and the pertinent installation described hereinabove and execution variations can be made without departing from the domain de the invention.

It should be recalled that the parameters (volumes, elution rates . . . ) and results indicated previously concern a prototype installation on the pilot scale, for a column 11 having a capacity of 60 l.

Such data will obviously need to be adapted for industrial installations.

In addition, the installation illustrated in the attached figure is adapted to implementing the process according to the invention in semi-continuous mode or per “batch”.

It is eminently feasible to utilise the process in continuous mode.

To do this, the installation illustrated in the attached figure will be completed by using at least two columns 11 arranged in parallel, each containing the resin 12 for fixing the anionic ZnCl₃⁻ complex; such columns 11 can then be used successively for the stages of the separation process of the zinc and of the nickel, or iron respectively, according to the invention.

Furthermore, it is important to note the different solutions, among which the extraction solutions or the washing solutions used within the scope of the present process, can advantageously be recycled, especially in the attempt to limit running costs.

1. A process for separation of zinc and a second metal not forming an anionic complex in the presence of chloride ions, the zinc and the second metal being present in an effluent (1, 9) in the form of ZnCl₂ and second metal chloride, comprised of forming and fixing the anionic ZnCl₃⁻ complex on a resin (12),
wherein the formation of the anionic ZnCl₃⁻ complex is obtained by placing the effluent (1, 9) in contact with the resin (12) saturated in chloride ions, and in that the process further comprises the stages of:
extraction of the second metal chloride by means of a first eluent (13), then
extraction of the zinc with the degree of oxidation +II.

2. The process as claimed in claim 1, wherein the second metal is a transition metal, preferably selected from Cr, Cu, Ni, and Fe.

3. The process as claimed in claim 1, wherein saturation of the resin (12) is performed by a solution whereof the concentration of chloride ions is greater than or equal to 0.7 mol/l approximately and, preferably, between 1 and 1.3 mol/l approximately.

4. The process as claimed in claim 3, wherein the solution enabling saturation of the resin (12) is a solution of HCl or NaCl.

5. The process as claimed in claim 1, wherein the first eluent (13) is a solution whereof the concentration of chloride ions is greater than or equal to 0.7 mol/l approximately and, preferably, between 1 and 1.3 mol/l approximately.

6. The process as claimed in any one of claims 1 to 5 claim 1, wherein the first eluent (13) is a solution of HCl or NaCl.

7. The process as claimed in claim 1 wherein the metal chloride, extracted by the first eluent (13), is precipitated with a precipitation reagent (16), preferably an alkaline reagent.

8. The process as claimed in claim 7, wherein the alkaline reagent is selected from soda, lime, and potassium.

9. The process as claimed in claim 7, wherein the precipitation reagent (16) is introduced in quantities reaching the pH corresponding to the minimum solubility of the second metal cation precipitate.

10. The process as claimed in claim 1, wherein the extraction stage of the zinc with the degree of oxidation +II is performed after complete extraction of the metal chloride.

11. The process as claimed in claim 1, wherein, after the extraction stage of the metal chloride, the process comprises a dissociation stage of the ZnCl₃⁻ complex to form ZnCl₂ and extraction of the ZnCl₂ thus obtained by means of a second eluent (21) allowing dilution of the concentration of chloride ions.

12. The process as claimed in claim 11, wherein the second eluent (21) is a solution whereof the concentration of chloride ions is less than 1 mol/l approximately.

13. The process as claimed in claim 11 or 12, wherein the second eluent (21) is selected from NaCl, water.

14. The process as claimed in claim 11, wherein the ZnCl₂ extracted by the second eluent (21) is precipitated with a precipitation reagent (24), preferably an alkaline reagent or a sulphide.

15. The process as claimed in claim 14, wherein the alkaline reagent is selected from among soda, lime and potassium.

16. The process as claimed in claim 14, wherein the precipitation reagent (24) is introduced in quantities reaching the pH corresponding to the minimum solubility of the precipitate of Zn₂+.

17. The process as claimed in claim 1, wherein, after the extraction stage of the metal chloride, the process comprises a desorption stage of the zinc with the degree of oxidation +II by transformation of the ZnCl₃⁻ complex into a zinc complex more stable than the ZnCl₃⁻ complex.

18. The process as claimed in claim 17, wherein the desorption stage is produced by a solution of ammonia.

19. The process as claimed in claim 1, wherein, after the extraction stage of the metal chloride, the process comprises an electrolytic desorption stage of the zinc with the degree of oxidation +II.

20. The process as claimed in claim 1, wherein it further comprises a previous extraction stage of the calcium present in the effluent (1).

21. The process as claimed in claim 20, wherein the extraction is produced by addition of sulphuric acid, in stoichiometric quantities.
